(19) United States
(12) Patent Application Publication
(10) Pub. No.: US 2011/0064917 A1
(43) Pub. Date: Mar. 17, 2011

(54) FAUX GLASS BEAD WALL COVERING PRODUCT AND PROCESS

(76) Inventor: Roy S. RITCHIE, North Caldwell, NJ (US)

(21) Appl. No.: 12/560,198

(22) Filed: Sep. 15, 2009

(51) Int. Cl. B32B 3/30; B05D 3/12; B05C 11/00

(52) U.S. Cl. 428/173; 427/359; 118/44

(57) ABSTRACT

The invention includes a faux glass bead wall covering (e.g., wallpaper and a metallic base media for the digital printing market), and the process/machine arrangement for making the covering. The covering is a two-ply material formed from a laminated vinyl material to a fabric weave backing material. The vinyl side of the material is embossed with a dense set of small bumps. The fabric is selected to reduce any Moiré effect created by the embossing process. The embossed material is then flood coated with glitter ink. The excess glitter ink is removed with a Mayer rod assembly, and the inked material is cured, resulting in a final product having an appearance substantially similar to glass bead wall coverings.

### BACKGROUND

Presently, the wall covering (e.g., wallpaper, etc.) market produces a product known as glass bead wallpaper, or similar glass bead coverings on various substrates. This product produces a shimmering covering in different colors or patterns with a rough texture created by actual glass beads or glass pieces forming the surface of the covering. In certain applications, the glass bead covering provides a unique look considered to be luxurious, and providing the appearance of a high quality elegance. Though the glass bead wall coverings come in various colors, textures, bead size/shapes, and patterns, all such variations are expensive to produce, and thus expensive to purchase. The glass bead wall coverings are also extremely difficult to install, and cannot be installed with the use of traditional wall covering installation methods. Additionally, since the glass bead wall coverings are constructed from an inflexible glass, they cannot be used in certain wall covering processes, such as custom printing, that are available for more traditional wall covering products.

Metallic substrates that can be used for custom printing are generally solid sheet metallic forms, such as Mylar or a comparable solid flat sheet with an aluminized appearance. These substrates usually include either a flat polished metalized surface, or a diffraction grading metalized surface. The flat polished surfaces will only reflect light in one direction. Thus, from one angle, relative to a light source, the substrate may appear black, yielding little or no detail of the image printed on the surface, while a different angle may produce a blinding glare, washing out the printed image. The diffraction grading surfaces can obtain an effective metallic look at some viewing angles. However, at other viewing angles these materials break up the incident light into its spectral components in a prism-like effect, which distorts the printed image. Additionally, to the extent these metallic products are capable of receiving a printed image, most are limited to “high impact” graphics, e.g., vibrant, solid colors. Continuous tone images, subtler colors such as pastels, and multi-colored, detailed images are not possible, to any acceptable degree of quality, on these known substrates.

### SUMMARY

Example embodiments of the present invention may provide a wall covering that is similar in aesthetics to glass bead wall coverings, but has a greater flexibility and is less expensive to produce. Example embodiments of the present invention may include the novel process and apparatus for creating the example covering. Example embodiments of the present invention may be achieved via a multi-step process, combining an embossed substrate with a glitter based ink. The example process may include laminating a two-ply covering of vinyl and fabric weave. The example process may include embossing the covering with a dense bump pattern, and applying a glitter ink to the embossed surface. The example process may include removing excess ink with a Mayer rod. Aspects of example embodiments may include the faux glass bead covering produced by the example process and the ability to digitally print an image on the covering.

Another example embodiment of the present invention may include an example method for creating an aesthetic covering. The example method may emboss a first substrate of a substantially flat flexible material to create a dense plurality of small bumps. Next, the example method may coat the embossed surface with an ink having a glitter content. Additionally, the example method may remove excess ink, such that a majority of remaining glitter is located in the recessed portions of the substrate.

Variations of this example embodiment may include laminating a second substrate to the first substrate to create a two-ply substrate on which the embossing is preformed. The first substrate may be made of vinyl, and the second substrate may be made of a 30 by 28 weave fabric of polyester and cotton. The example method may use a flood coating process, and/or a Mayer rod for removing excess ink (e.g., a number 5 Mayer rod).

Another example embodiment of the present invention may include an example apparatus for creating an aesthetic covering, including an embossing roll configured to receive and emboss a substrate to create a dense plurality of small bumps. The example apparatus may include an ink pan configured to hold ink having a glitter content. The example apparatus may include an applicator roll configured to apply ink to the substrate. The example apparatus may include an ink reduction roll configured to remove excess ink from the substrate.

Variations of this example embodiment may include a laminator configured to join an embossable substrate to a backing substrate. The example backing substrate may be a fabric weave. The example applicator roll may be partially submerged in a volume of ink. The ink may be a glitter ink.

Another example embodiment of the present invention may include an aesthetic covering made of an embossed material with an ink coating. The material may be flexible. The embossed design may include a dense plurality of bumps. The ink coating may include a glitter content. The glitter content of the example covering may be primarily or mostly located in the recesses between bumps. In variations of the example embodiment, the ink coating may have been applied via a flood coating process with a Mayer rod to remove excess coating. The material may be made of a vinyl. The covering may also be configured to be run through a digital printer and receive a printed design. The example covering may also include a backing material laminated to the embossed material.

### BRIEF DESCRIPTION OF THE DRAWINGS

FIG. 1 is a flowchart illustrating an example process for creating an example faux glass bead wall covering.

FIG. 2 is a diagram illustrating an example apparatus for creating an example faux glass bead wall covering.

FIG. 3 is an illustration of some aspects of an example faux glass bead wall covering.

### DETAILED DESCRIPTION

Example embodiments of the present invention may include a multi-step process for constructing a faux glass bead wall covering. Generally, the first phase of an example process may include constructing a textured covering designed to simulate the visual structure of glass bead coverings. The second phase of this example process may include applying a glitter ink to the textured covering to simulate the visual luster of glass bead coverings. An optional step unique to example embodiments may include printing a custom image or design onto the wall covering.

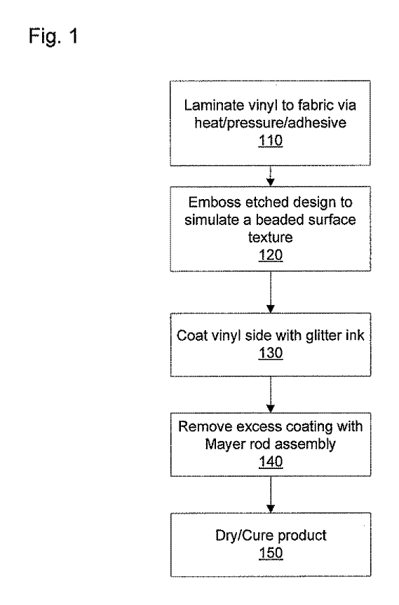

FIG. 1 may illustrate a process for constructing a faux glass bead wall covering, according to an example embodiment of the present invention. At 110, the example process may create a flexible and durable substrate, capable of holding a pressed design. In the example of FIG. 1, a vinyl covering surface is laminated to a fabric under-surface. Other embodiments may arrange a pressed design substrate with no additional backing, or more than a 1-ply backing. However, the backing may provide greater durability to the overall design. The backing may provide better acceptance for an adhesive used for applying the covering to the wall. Additionally, wall covering backings may provide a greater “stripability” factor, e.g., the ease at which it may be removed from the wall without fragmenting. The laminating process may include the application of heat, pressure, adhesives, or any other substance/process designed to form the base structure for the covering. Any color vinyl may be used to create different final products (e.g., silver, gold, white, etc.). A pad coat of a metallic ink may also be coated on the vinyl prior to embossing in order to add an additional design enhancement and flash of color to the underlying vinyl. Also, different configurations of fabric backs may be used. Certain backings may create a Moiré effect on the vinyl surface, once the embossing process is performed. One advantageous selection may be a 30 by 28 weave (i.e. 30 threads per inch of width by 28 threads per inch of length), composed of 65 percent polyester and 35 percent cotton warp with a 100 percent filling. Other backings may overcome the Moiré effect, and any backing that reduces or eliminates this aesthetic defect may be used (e.g., the 30 by 28 weave). In an alternative example embodiment, a backing may be selected that does not reduce the Moiré effect, e.g., when this visual effect is the desired result.

Next, at 120, the two-ply covering may have the vinyl surface embossed with a dense bumpy pattern, designed to simulate small glass beads. This process may also be performed in conjunction with the lamination process. The embossed pattern may be in any size, but advantageously the bump pattern may include a dense set of smaller protrusions (e.g., about a millimeter in diameter or smaller). The embossing process includes running the two-ply covering through a machine with a patterned embossing roller. The roller, with pressure and/or heat, may leave the embossed pattern in the vinyl, such that the protrusions of the embossed vinyl are created by the recesses in the roller pattern.

The lamination process to construct the two-ply material and the embossing process may also be performed by a single machine. In one example embodiment, an adhesive coating may be applied to one side of the vinyl substrate. The vinyl and fabric may then be brought together and run over a steam-filled steel drum in order to cure the adhesive. Other heating mechanisms may be used. This process also results in the vinyl being heated to an ideal temperature for the embossing process that may occur as the next step in this process. Different vinyl compositions and configurations may have different optimal temperatures, e.g., 310 degree Fahrenheit. The two-ply covering with the heated vinyl, may now be fed through an embossing roll. The embossing roll may be chilled and may apply a high pressure (e.g., by “sandwiching” the vinyl between the embossing roller and another roller). The embossing design etched in the embossing roller may imprint the embossed design in the hot vinyl. The chilled embossing roller may simultaneously cool the vinyl, which may cause the vinyl to hold the embossed shape.

The embossing pattern is laid out to look like the conventional glass bead wall coverings while reducing visual defects. Visual defects may arise in any number of forms. An example might include tracking. A “tracking” defect may occur when certain embossing features line up, either in a single strip or when strips are installed together. These undesirable patterns may cause lines, tracks, or other unnatural patterns to be visible in the final product. These patterns should not exist in traditional glass-bead wall coverings, and thus example embodiments of the present invention may implement an embossing design that reduces any “tracking” defects.

Creating the embossing design may be accomplished in a number of ways. For example, a real glass bead wall covering sample may be used to design a vinyl sample that will closely replicate the original look and layout. This vinyl sample may then be examined and tested for known defects and patterns (e.g., tracking). Any specific problem areas may be rearranged to eliminate any visual defects caused by those areas. The size, shape, and spacing of the embossing “bumps” on the roller may be adjusted in certain areas to implement the desired changes. Example prints from the roller pattern may be produced (e.g., in black and white for greatest contrast during examination). Several derivations of the base design may be produced and inspected, until a final design is approved. The final design may be selected for its lack of visual defects and otherwise authentic appearance.

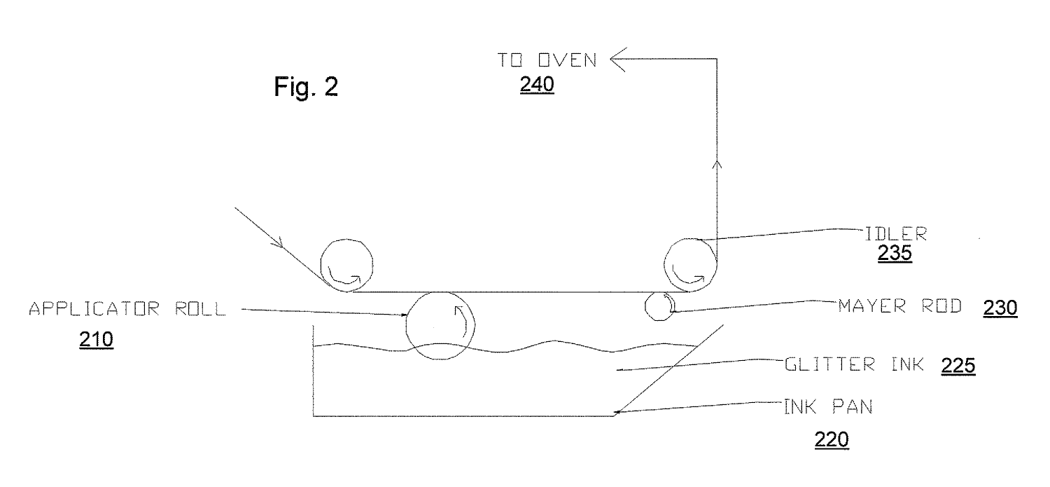

Once the two-ply covering is embossed, it will be sent through an ink-coating process. FIG. 2 illustrates an example machine configuration for this process. At 130, the embossed covering is fed to the applicator roll 210, with the vinyl side down, e.g., making contact with the applicator roll, which will apply the ink 225 to the embossed vinyl. The ink 225 may be held in an ink pan 220, in which the applicator roll 210 is partially submerged. Next, at 140, excess ink is removed with a Mayer rod assembly, e.g., 230 and 235.

There may be some variation in a Mayer rod assembly, but the most common arrangement includes a stainless steel rod wound tightly with stainless steel wire of varying diameter. The rod is used to remove excess coating solution and control the coating weight. The thickness of the ink coating after passing through the Mayer rod assembly is controlled by the diameter of the wire used to wind the roll and is approximately one tenth the wire diameter. One advantageous arrangement has been found by using a single number five wire Mayer rod in the product assembly. Other variations (e.g., gapped rod, threaded rod, etc.), combinations (e.g., an additional smoothing rod), sizes (e.g., a number three Mayer rod), and configurations are also possible.

In addition to the Mayer rod configuration and the embossing design, another variable element of the process may include the viscosity of the ink coating solution. The dynamic viscosity of the coating solution, in combination with the embossed pattern and Mayer rod configuration, will determine the thickness and application of the final ink-coat layer. Different viscosities may be used to achieve different effects. One example embodiment may use a solution of 35+/−2 seconds measured on a number two Zahn cup, or 80 centipoises. The example embodiment may correlate to a fluid thicker than water, but still having a relatively quick flow. Other viscosities may be selected for other example embodiments.

After the inking process, the wall covering may then be cured at 150, e.g., in an oven 240. Any process to dry and finalize the wet ink coating is possible, but typically a specialized oven is used to create the final wall covering product. The ink 225 may be a glitter ink, including a substantially translucent base adhering ink with appropriately colored and sized glitter mixed in. Glitter is conventionally made of small fragments of a base material (metal, plastic, glass, etc.) and if needed, a coloring agent. The coloring agent is also selected to reflect light to create a shimmering effect. The glitter ink may be deposited on the whole surface via the applicator roll. The Mayer rod may then remove most of the glitter ink from the bump portion of the embossed vinyl, leaving a glitter deposit in the recessed area of the vinyl. The final product creates a glass bead effect through the dual features of a three dimensional bead-type embossing, and the light reflecting glitter ink, deposited primarily in the recessed portion of the embossed vinyl.

This final product provides an appearance substantially similar to glass bead wall coverings, but requires a fraction of the cost to produce. The product is also easier to install. This provides great benefit over the products currently available in the market. Additionally, the example product described herein provides an additional benefit that glass bead wall coverings cannot. Specifically, wall coverings (e.g., two-ply vinyl fabric wall coverings) may have any design, picture, graphic, logo, or other image printed onto the covering with printers designed to do the same. Since the example products described herein may include a covering surface that ink adheres to (e.g., vinyl), the example faux glass bead wall covering material may also be used in conjunction with the wall covering printers. Conventional glass bead wall coverings are made from actual glass beads, which cannot be run through a precision printer, and cannot reliably retain an ink solution. Thus, conventional glass bead coverings cannot provide this function that the example faux glass bead covering may provide.

The essentially random placement of the metallic flakes in example embodiments, should reflect light from every angle, and avoid the viewing angle deficiencies of conventional metallic coverings. Further, as with any printing base, the closer the base is to a neutral white, the clearer the image it may receive. Sheet metallic substrates, by their nature, are grey, a color that does not easily accept printed images. This is a key reason why conventional metallic substrates are confined to vibrant color graphics, without great detail or any subtle colors. Likewise, available Mylar will come in various colors that hinder the printed image presentation. The example embodiment of the present invention described above, uses only a coating of metallic flakes, randomly deposited on the embossed surface. As a result of this, the majority (e.g., 90%) of the underlying vinyl is left exposed, while still achieving a metallic effect. The underlying vinyl may be formed from a pure white, or a similarly neutral color, while being coated with metallic colored flakes (e.g., silver). In this way, instead of 100% of the image being printed onto metallic colors (e.g., as with conventional substrates), 90% may be printed on a neutral vinyl color, with the last 10% printed on the metallic color of the randomly deposited flakes. This may achieve a large gain in image clarity, allowing for continuous colors, subtle colors, and detailed images to be printed on the example embodiments.

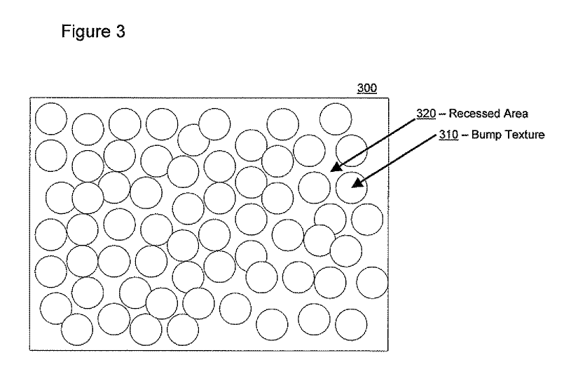

FIG. 3 illustrates one two-dimensional illustration of the embossed vinyl side of the covering 300. The circles 310 may represent one millimeter bumps created by the recessed portion 320 (e.g., the rest of the area), which was created by the embossing process. The area of FIG. 3 may be roughly 11 millimeters wide by 8 millimeters in length. Though the dimensions of the covering, as well as the relative dimensions and density of the embossed bumps may both be fully customized, the proportions are given to illustrate the relative size and density of one example embodiment. This sheet portion, or a larger sheet with many more bumps, may be the faux glass bead wall covering sheet that is run through a wall covering printer capable of printing on vinyl wall coverings.

It should be understood that there exist implementations of other variations and modifications of the invention and its various aspects, as may be readily apparent to those of ordinary skill in the art, and that the invention is not limited by specific embodiments described herein. Features and embodiments described above may be combined. It is therefore contemplated to cover any and all modifications, variations, combinations or equivalents that fall within the scope of the basic underlying principals disclosed and claimed herein.

What is claimed is:

1. A method of creating an aesthetic covering, comprising:
embossing a surface of a first substrate of substantially flat flexible material to create a dense plurality of small bumps;
coating the embossed surface with an ink having a glitter content; and
removing excess ink, such that a majority of remaining glitter is located in recessed portions of the substrate.

2. The method of claim 1, further comprising:
laminating a second substrate to the first substrate to create a two-ply substrate on which the embossing is preformed.

3. The method of claim 2, wherein the first substrate is made of vinyl.

4. The method of claim 2, wherein the second substrate is made of fabric.

5. The method of claim 4, wherein the fabric is a 30 by 28 weave including at least one of polyester and cotton.

6. The method of claim 1, wherein the coating is performed as a flood coating process.

7. The method of claim 1, wherein the removing of excess ink is preformed by a Mayer rod.

8. The method of claim 7, wherein the Mayer rod is a standard number 5 Mayer rod.

9. An apparatus for creating an aesthetic covering, comprising:
an embossing roll configured to receive and emboss a substrate to create a dense plurality of small bumps;
an ink container configured to hold ink having a glitter content;
an applicator roll configured to apply ink to the substrate; and
an ink reduction roll configured to remove excess ink from the substrate.

10. The apparatus of claim 9, further comprising:
a laminator configured to join an embossable substrate to a backing substrate.

11. The apparatus of claim 10, wherein the backing substrate is a fabric weave.

12. The apparatus of claim 9, wherein the applicator roll is partially submerged in a volume of ink.

13. An aesthetic covering, comprising:
an embossed material with an ink coating,
the material being flexible,
the embossed design including a dense plurality of bumps, and
the ink coating including a glitter content.

14. The aesthetic covering of claim 13, wherein the glitter content of the ink coating is substantially located in recesses between bumps.

15. The aesthetic covering of claim 14, wherein the location of the glitter content is achieved by flood coating the substrate and removing excess ink with a Mayer rod.

16. The aesthetic covering of claim 13, wherein the material is vinyl.

17. The aesthetic covering of claim 13, wherein the covering is configured to be run through a digital printer and receive a printed design.

18. The aesthetic covering of claim 13, further comprising:
a backing material, wherein the backing material and embossed material are laminated together.

19. The aesthetic covering of claim 18, wherein the backing material is a fabric weave configured to reduce a Moiré effect created by an embossing process.
